(19) United States
(12) Patent Application Publication
(10) Pub. No.: US 2009/0073032 A1
(43) Pub. Date: Mar. 19, 2009

(54) Apparatus, system and method for global positioning, monitoring, and communication

(75) Inventors: Saeed Corangi, Berkshire (GB); Malcolm Cockcroft, Berkshire (GB); Kamil Wysocki, Streatley (GB)

Correspondence Address: Martin G. Ozinga;Phillips Murrah, P.C., Corporate Tower, 13th Floor, 101 N. Robinson Ave., Oklahoma City, OK, 73102, US

(73) Assignee: SMC ELECTRONICS, LTD.

(21) Appl. No.: 12/156,108

(22) Filed: May 29, 2008

Related U.S. Application Data
(60) Provisional application No. 60/934,195, filed on Jun. 12, 2007.

(51) Int. Cl. G01S 1/00

(52) U.S. Cl. 342/357.06

(57) ABSTRACT

The current invention relates to a positioning, monitoring, and/or communications device, system and method. The invention generally comprises an application utilizing a position determining system, a short range communication system, and a long range communication system, wherein all technologies are available to a user in one seamless utility. The invention further provides means for automatically switching to the desirable form or available form of the previous technologies as well as combinations thereof.

### CROSS-REFERENCE TO RELATED APPLICATIONS

Priority is claimed from provisional patent application U.S. Ser. No. 60/934,195 filed on Jun. 12, 2007, and incorporated by reference herein.

### BACKGROUND OF THE INVENTION

1. Field of the Invention

In general, the present invention relates to global positioning, monitoring and/or communication. More particularly, the present invention relates to a new and improved apparatus, system, and method to utilize multiple forms of known technology, such as but not limited to radio, GPS, satellite communications, GSM/GPRS, and combinations thereof for allowing accurate positioning, monitoring, and communications. It is understood that the invention is not limited to specific technology applications. Likewise, the invention may include new and improved technologies for accomplishing same.

2. Description of the Prior Art

Modern technology through the development of electronics has greatly improved the daily lives of mankind in how it communicates, functions, and travels. And although numerous advances have occurred in a relatively short span, the current status of technology still has many shortcomings in how we globally position, monitor, and communicate due to the known limitations in the prior art.

By very brief example, modern technology such as Global System for Mobile communications (also known as GSM), General Packet Radio Service (also known as GPRS), both commonly referred to collectively as GSM/GPRS, has obvious shortcomings due to the need for networks. For obvious reasons, these systems are not currently suited for use associated to the open seas. Traditional radio has numerous known shortcomings such as signal transmission and reception interference associated with obstacles in transmission paths such as mountains and so forth.

Satellite technology is a viable alternative and known to solve some of the aforementioned problems, but also suffers obvious shortcomings. Global positioning systems or global positioning satellites (also known as GPS) are still fundamentally used for positioning and, however, not with communications due to the nature of the system. Furthermore, satellite “phone” technology is generally costly and commercially unfeasible for mass communication and information exchange as the current state of the art.

What is needed is a means to reap the benefit of these different available technologies by utilizing some or combinations of all to accomplish a better positioning, monitoring and/or communications system with global applications. What is also needed is a product that successfully solves the preceding problems known in the prior art and combines multiple mediums of communication into one easy to use system. Of note, the current invention is not necessarily directed strictly to the listed technologies and the used terminology should not be considered limiting as such. It is further understood and contemplated that the current invention may be used in association with other applications, utilities, and technologies.

The current industry is constantly looking for effective, durable, and cost effective positioning, monitoring, and communications apparatus, systems and methods for implementation of same. Thus, there is a need for a new and improved apparatus, system, and method of use as generally outlined above which combines the benefits of known technologies. The current invention provides a means where the prior art fails.

### SUMMARY OF THE INVENTION

In view of the foregoing disadvantages inherent in the known types of apparatus, systems and methods present in the prior art, the present invention provides a convenient, easily used, accurate, and dependable positioning, monitoring, and communications apparatus, system and method. As such, the general purpose of the present invention, which will be described subsequently in greater detail, is to provide a new and improved apparatus, system and method which allows for accurate and real time positioning, monitoring, communication and combinations thereof which has many of the advantages of the prior art mentioned heretofore and many novel features that result in a new positioning, monitoring, and communications apparatus, system and method which is not anticipated, rendered obvious, suggested, or even implied by any of the prior art apparatus, systems or methods, either alone or in any combination thereof.

To attain such, the present invention may include utilization of one or more forms of known technology such as but not limited to radio, GPS, satellite communications, and GSM/GPRS wherein the invention may automatically switch to the most desired or cost effective means with zero to minimal manual intervention. In a preferred embodiment and for purposes of example, in an area of radio coverage, the hardware would use that network to transmit positional, voice, and sensory data. If radio coverage is lost, it may automatically switch to the GSM/GPRS networks, if coverage is lost there, it may send the data via satellite without losing any data in the process.

There has thus been outlined, rather broadly, the more important features of the present invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Therefore, it is an object of the present invention to provide a new and improved apparatus, system and method for global positioning, monitoring and/or communication.

It is a further object of the present invention to provide a new and improved apparatus, system and method for global positioning, monitoring and/or communication which is of a durable and reliable construction and may be easily and efficiently applied, manufactured, and marketed.

An even further object of the present invention is to provide a new and improved apparatus, system and method for global positioning, monitoring and/or communication which is susceptible to a low cost of application with regard to both materials and labor, and which accordingly is then susceptible to low prices of sale to the consuming industry, thereby making such invention economically available to those in the industry and public in general.

Still another object of the present invention is to provide a new and improved apparatus, system and method for global positioning, monitoring and/or communication which provides all of the advantages of the prior art, while simultaneously overcoming some of the disadvantages normally associated therewith.

While still another object of the present invention is to provide a new and improved apparatus, system and method for global positioning, monitoring and/or communication which may provide optimal real time operations globally.

It is a further object of the present invention to provide a new and improved apparatus, system and method for global positioning, monitoring and/or communication which allows for automatic switching to the most desirable means without need of operator assistance.

Furthermore, it is a further object of the present invention to provide a new and improved apparatus, system and method for global positioning, monitoring and/or communication which allows an operator to retrieve specific data, such as but not limited to constant or near constant monitoring of assets.

Still furthermore, it is a further object of the present invention to provide a new and improved apparatus, system and method for global positioning, monitoring and/or communication which provides a wireless means that may generally be utilized in multiple government applications such as but not limited to hazardous material security, post disaster communications, logistics tracking for post and pre-disaster response, and urban operations support.

Yet another object of the present invention is to provide a new and improved apparatus, system and method for global positioning, monitoring and/or communication which provides a wireless means that may generally be utilized in commercial applications such as but not limited to fleet management, data recording and distribution, as well as personal use such as but not limited to personal protection and vehicle tracking.

Still another object of the present invention is to provide a new and improved apparatus, system and method for global positioning, monitoring and/or communication which provides a wireless means that may generally be utilized in emergency service applications such as but not limited to vehicle tracking and routing as well as personnel tracking and monitoring.

These, together with other objects of the invention, along with the various features of novelty, which characterize the invention, are pointed out with particularity in the claims annexed to and forming a part of this disclosure. For a better understanding of the invention, its operating advantages, and the specific objects attained by its uses, reference should be had to the accompanying drawings and descriptive matter in which there are illustrated preferred embodiments of the invention.

The present invention referred to throughout may be embodied in other specific forms without departing from its spirit or essential characteristics. The described embodiments are to be considered in all respects only as illustrative and not restrictive. Furthermore, each of the methods that have been described should also be considered only as illustrative and not restrictive.

### BRIEF DESCRIPTION OF THE PICTORIAL ILLUSTRATIONS GRAPHS, DRAWINGS, AND APPENDICES

The invention will be better understood and objects other than those set forth above will become apparent when consideration is given to the following detailed description thereof. Such description makes reference to the annexed pictorial illustrations, graphs, drawings, exhibits and appendices.

FIG. 1 shows a schematic representation of a global positioning, monitoring, and communication system constructed in accordance with the present invention.

FIG. 2 shows a schematic representation of an alternate embodiment of a global positioning, monitoring, and communication system constructed in accordance with the present invention.

FIG. 3 shows a schematic representation of an alternate embodiment of a global positioning, monitoring, and communication system constructed in accordance with the present invention.

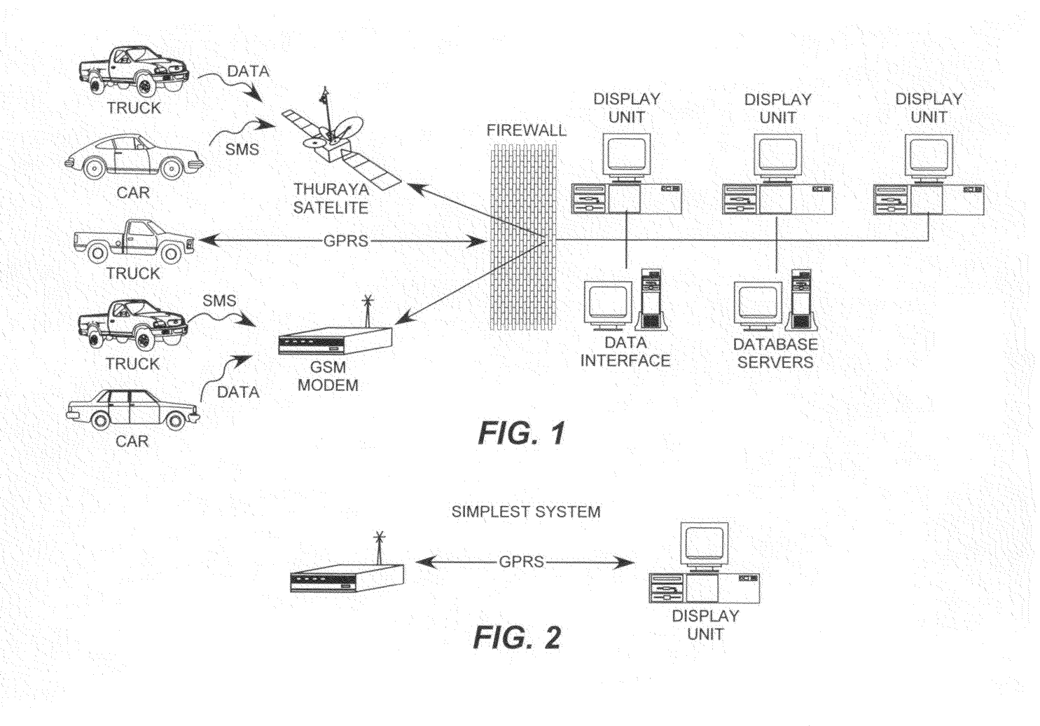

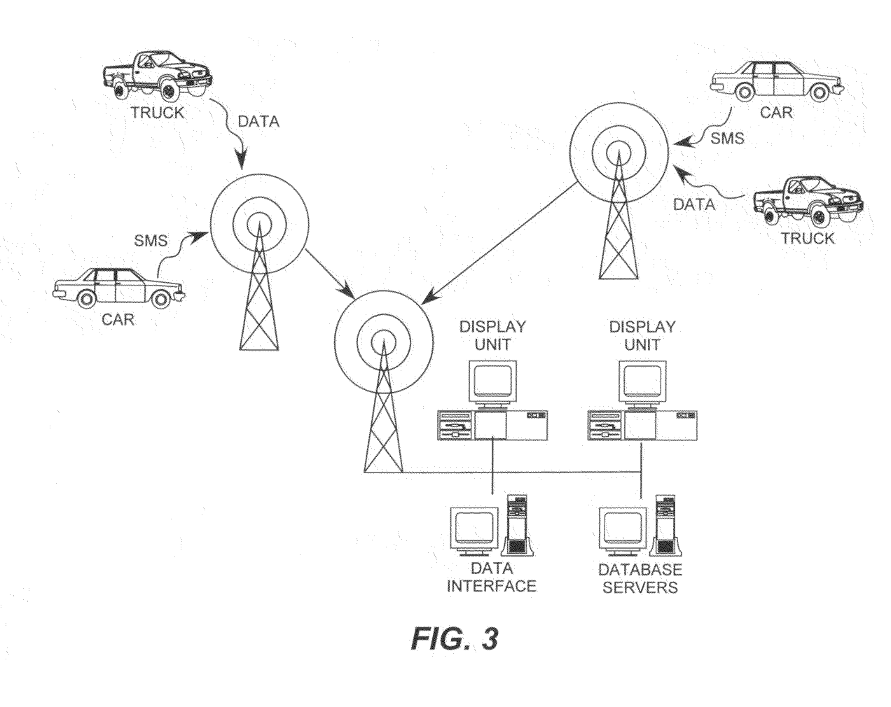

### DETAILED DESCRIPTION OF THE PREFERRED EMBODIMENTS

The current invention may be classified as a system, method, apparatus, and/or combinations thereof. The following detailed description does not define any aspect in a particular order of importance but rather attempts to organize the following for convenience only. It is contemplated that the current invention may generally comprise an application utilizing a position determining system, such as but not limited to GPS; a short range communication system, such as but not limited to means for accessing a radio network, an 802.11 network, a HomeRF network, a HiperLAN or a BLUETOOTH network; a long range communication system, such as but not limited to means for accessing a satellite network; and a telecommunication network, such as but not limited to means for accessing a CDMA, TDMA, GSM/GPRS network, wherein all technologies are available to a user in one seamless utility. In a preferred embodiment, the invention may automatically switch to the desirable form or available form of the previous technologies as well as combinations thereof. It is understood that the term “desirable” may mean cost effective, reliable, efficient and such inputs are predetermined by the user's wants and needs.

In a preferred embodiment, the present invention consists of a communications device comprising a short range communication system, a long range communication system, and means for automatically switching between the short range communication system and the long range communication system based on a set of predetermined inputs.

In another preferred embodiment, the present invention consists of a system for positioning, monitoring, and communicating, wherein the system comprises a plurality of communication networks, and a device for accessing the plurality of communication networks, wherein the device includes means for switching between the communication networks.

One of the biggest weaknesses with traditional real-time GPS systems today is limited coverage for sending and receiving positional and sensory data. This limited coverage is caused by an incomplete true nationwide/worldwide GSM/GPRS network, as traditional real-time GPS transmits data over this network; it is only as good as the network's coverage. The current invention may combine three of the major methods of communication with at least six channels. The invention may transmit data over the traditional GSM/GPRS networks and is quad-band compatible although not limited to those four bands, and may also incorporate radio and satellite methods of communication in one unit. It is contemplated that the current invention may provide worldwide or almost worldwide coverage to send positional, sensory, and voice data.

By example, it is contemplated in accordance with a preferred construction of the invention, in an area of radio coverage, the hardware would use that network to transmit positional, voice, and sensory data. If radio coverage is lost, it may automatically switch to the GSM/GPRS networks, if coverage is lost there, it may send the data via satellite without losing any data in the process. Furthermore, it is contemplated that the current invention solves the limited coverage provided by GSM/GPRS, provides real-time tracking solutions, eliminates or minimizes lost signals, gives accurate position information, and provides voice and sensory data.

Configurations for the GSM/GPRS Tracking System may consist of the following:

GSM/GPRS Tracking System

| | | |
|---|---|---|
| Modes | GSM/GPRS | GSM-900 GSM-850 DCS-1800 PCS-1900 |
| | GPS | L1 (1575.42 MHz) |
| GPS | Reacquisition | |
| acquisition | Cold | <60 Secs |
| time | Warm | <40 Secs |
| | Hot | <2 Secs |

| | |
|---|---|
| Position Accuracy | 5 Meters |
| Internal GSM Antenna | Ceramic Patch Antenna |
| Battery Power | 600-1000 mA Lion Battery |
| External Power | 6-16 V. 350 mA |
| Operation Time | Depends upon mode used |
| Operating Temperature | −10 to +60 C. |
| Relative Humidity | .5-95% Non-condensing @ 45 C. |
| Alert | Front Panel Button |
| GSM/GPRS Antenna | SMA GSM/GPRS Antenna connector |
| Optional Antenna | An optional antenna may be provided |
| Saved Readings | Up to 8,000 Readings Stored |
| Data Rate | Programmable |
| Data Rate Range | From 10 Seconds to 24 Hours/Reading |
| Transmission Rate | Programmable |
| Transmission Mode | GPRS/Data Modem/SMS |
| Mode Selection | Programmable |
| Programming | On Site through front panel connector |
| Internal Devices | Several extensions are available. |
| | Analogue/digital input/output. Alarm inputs. |
| | BLUETOOTH communications. USB |
| | communications. |
| External Devises | The unit may be programmed to transmit any |
| | data connected to the front panel serial port. |

In a preferred embodiment the mediums or technology used may include all GSM/GPRS quad-band frequencies (850/900/1800/1900 MHz), 150/400 MHz, and any additional radio band, and satellite utility. This combination of mediums coupled with automatic switching features may eliminate or reduce any lost signals, positional, voice, and sensory data. It is also contemplated that the invention may include a data delivery and notification program to the sender to verify that all data sent has actually been received, when received, and so forth.

Configurations for the Radio Base Station Device may consist of the following:

Radio Base Station System

| | |
|---|---|
| Frequency | 165-175 MHz |
| Output Power | 25 W |
| Antenna | External BNC Connector |
| Power | 230 V |
| Data Connection | 9-Way DB Connector |
| Operating Temperature | −10 to +60 C. |
| Relative Humidity | 5-95% Non-condensing at 45 C. |

Configurations for the Radio System Device may consist of the following:

Radio System

| | | |
|---|---|---|
| Frequency | | 135-175 MHz |
| GPS | Frequency | L1 (1575.42 MHz) |
| Acquisition | Cold | <60 Secs |
| | Warm | <40 Secs |
| | Hot | <2 Secs |

| | |
|---|---|
| Output Power | 25 W |
| GPS Connector | SMA Connector |
| Radio Connector | BNC Converter |
| Power | 230 V |
| Data Connection | 9-Way DB Connector |
| Operating Temperature | −10 to +60 C. |
| Relative Humidity | 5-95% Non-condensing at 45 C. |
| Battery Power | External 12 V Battery available |
| External Power | 12-15 V |
| Alert | Front Panel Button |
| Saved Readings | Up to 8000 Readings Stored |
| Data Rate | Programmable |
| Data Rate Range | From 10 Seconds to 24 Hours/Reading |
| Transmission Rate | Programmable |
| Transmission Mode | GMSK 9500 |
| Mode Selection | Programmable |
| Programming | On Site through front panel connector |
| External Devices | The unit may be programmed to transmit any |
| | data connected to the front panel serial port. |

In accordance with a preferred embodiment, the invention may include a sensory application. It is contemplated that the hardware may be very flexible to operate numerous applications and outfitted with many connectors for various utilities, applications, devices and so forth. For example, the invention may utilize 20-pin connectors and perform twenty different functions remotely. These functions may be as vast as the sensors or hardware the connector is tied to, such as but not limited to rolling up windows, starting a car, shutting off a car, measuring seismic data, measuring heart rate, measuring body temperature, and so forth, all from across the world.

It is further contemplated that the invention may utilize standard Short Message Service (SMS) features, including an alarm button which has the function of forcing its message through any means of communication available, then on to the desired location such as a headquarters. This is important in areas of the world where crime is more prevalent and hijackings are common. The headquarters may then decide what to do with the vehicle if it is properly equipped with the mentioned sensors and so forth above. This may also apply for SOS occurrences where a driver, personnel, or even sensory data reads at a point of concern, to inform the correct people of the alarm.

It is also contemplated that the invention may include inclusion and exclusion zones wherein proprietary software may include user defined go and no-go zones that mark either a route to be taken, or zones of non-entry. This may apply to trucking companies being alerted of a truck off route, or for military personnel or vehicles that have wondered into hostile territory.

In a preferred embodiment, it is contemplated that the invention may include a remote standby and logging means. The invention may include a battery saving sleep mode for applications where no direct power source is available. This applies to container tracking and also for personnel should they require it. A sleep or standby mode can be turned on or off remotely via SMS anywhere in the world. Current positional, voice, and sensory data can be received, then the unit can return to standby. The battery pack may have an estimate lifespan of 6 months of standby time. It is understood that numerous power sources may be utilized as well as longer or shorter intervals.

It is still further contemplated that the invention may include BLUETOOTH technology applications. It is understood that it is no longer required to hardwire your PDA or laptop to GPS systems, and the current invention may interface with any compatible BLUETOOTH enabled hardware to provide visual, positional, sensory, and voice data.

The current invention may include hazardous material security. One of the most urgent issues facing homeland security planners at the federal, state and local levels is the difficulty in protecting shipments of highly lethal hazardous cargo, much of which transits close to heavily populated areas. Solutions to this issue are limited by the difficulty of securing numerous and highly mobile shipments that are often part of highly synchronized supply chains. The current invention may include a potential solution to this problem through the tracking, the delimitation of routes, and intervention in cases of suspicious vehicle actions. Because truck routes often cross through developed as well as rural areas, the ability to maintain contact through multiple communications avenues could have significant advantages.

The current invention may include pre- or post-disaster communications systems. One of the major problems highlighted by Hurricane Katrina was the lack of situational awareness and communications on the ground in the immediate aftermath of Katrina. Having multiple channels through which to complete communications could be an important part of FEMA's and other federal, state, and local communications strategies.

The current invention may further include container tracking. Maintaining awareness of the flow of shipping containers is a priority for the U.S. Department of Homeland Security (DHS). This is particularly driven by the fear of a nuclear device being shipped into the country. The current invention may be utilized to include passive and active tracking devices. It is contemplated the current invention may be a low cost, highly reliable tracking device, which continues to be an unfulfilled requirement.

Still further, the current invention may include logistics tracking such as for pre- or post-disaster response. After Hurricane Katrina, DHS recognized that it lacked the ability to track in a sophisticated way the goods and materials that it was sending as part of relief operations. The current invention may include a capability for total asset visibility in which it can track goods throughout the storage and delivery chain.

Further, the current invention may include urban operations support. Communications reliability is at a premium in Iraq and other theaters where there is diversity of terrain and a mixture of infrastructures. The military, depending on current capabilities both on land and in small boats, may utilize the current invention to enhance communications capabilities.

It is also contemplated the current invention may include fleet management. In order for companies to remain efficient they must continue to minimize cost and maximize profit in all areas. One element that has lacked for companies in control of small, or large fleets has been a sufficient way of tracking vehicles at any given time. This poses a problem for companies that work nation wide and constantly travel in areas where GSM/GPRS coverage is non-existent and traditional GPS systems become obsolete. It is contemplated the current invention may fill these gaps with no interruptions and in 100% real time. The same applies for marine equipment and fleets. Sensory hardware can be utilized to commit almost all functions the vehicle is capable. The current invention use of a GPS system may also be used for route planning and guidance, such as for taxicab companies in regards to guidance. The closest cab to a taxi request can be tracked and routed to the customer via GPS. It is further contemplated the current invention may include vehicle tracking/routing in general for emergency services. The same applies here in the taxicab scenario above; the closest emergency services can be routed to a scene of incident by tracking these units remotely and determining which is closest.

It is further contemplated the current invention may include data recording and distribution. It is understood that the invention may not just be a tracking solution; it can also be used at remote sites to record any kind of sensory data. This data can range from PSI on oil rigs, seismic activity, and temperature readings and so on, it is only limited by the sensors it is attached to and the bandwidth of the media of communication used. To power such applications if no direct power source is available, alternative sources like solar technology may be available.

It is also contemplated the current invention may include personnel tracking/monitoring. The current invention may continually track and monitor on a by-person basis. Sensory applications can read heart rate, body temperature, and other vitals. This is particularly important in tactical situations and with firefighters. Logistics and operations can be monitored on the tactical side, along with two-way communication with the agents. Firefighter application applies more to vitals monitoring and alarms programmed to alert the headquarters and the firefighter that fainting, for example, may be imminent.

It is further contemplated the current invention may include personal protection systems. As kidnapping is more and more prevalent in less developed countries, and particularly Mexico, the need to trace children of “important people” is becoming more of a need. Especially with Mexico's incomplete GSM/GPRS network a solution with combined media's is of an essence. The tracking data for this type of personnel tracking may include positional and voice data along with SMS texting capability.

It is still also contemplated the current invention may include general personal vehicle tracking and geo-fencing capabilities. The invention may include a system such as GM's ONSTAR® for remote vehicle access, theft deterrence, and so on.

It is understood that the following description of the components and methodology is not intended to be exhaustive and that specific examples, percentages, quantities, or details known in the art may be substituted or added. Furthermore, it is contemplated that the invention may be used in combination with one or more apparatus, systems or methods of the conventional and non-conventional nature. Still furthermore, it is contemplated that the current invention may be used with existing apparatus, systems and methods.

A number of implementations have been described herein. Nevertheless, it will be understood that various modifications may be made. Accordingly, other implementations are within the scope of the following claims. Changes may be made in the combinations, operations, and arrangements of the various parts, elements, and amounts described herein without departing from the spirit and scope of the invention.

What is claimed is:

1. A communications device comprising:
a short range communication system;
a long range communication system; and
means for automatically switching between the short range communication system and the long range communication system based on a set of predetermined inputs.

2. The communications device of claim 1, wherein the communications device further includes a position determining system.

3. The communications device of claim 1, wherein the short range communication system includes means for accessing a radio network, an 802.11 network, a HomeRF network, a HiperLAN or a BLUETOOTH network.

4. The communications device of claim 1, wherein the long range communication system includes means for accessing a wireless telecommunication network or a satellite network.

5. The communications device of claim 2, wherein the position determining system includes means for accessing a GPS.

6. The communications device of claim 4, wherein the wireless telecommunication network is a CDMA, TDMA, GSM or GPRS network.

7. A system for positioning, monitoring, and communicating, the system comprising:
a plurality of communication networks; and
a device for accessing the plurality of communication networks, wherein the device includes means for switching between the plurality of communication networks.

8. The system of claim 7, wherein the plurality of communication networks includes a short range communication network, a long range communication network, or a network of global positioning satellites.

9. A method for positioning, monitoring, and communicating, the method comprising the steps of:
determining available communication networks based on a user's preferences for accessing a communication network; and
switching between available communication networks.

10. The method of claim 9, wherein available communication networks includes a short range communication network, a long range communication network, or a network of global positioning satellites.
